(19) United States
(12) Patent Application Publication
(10) Pub. No.: US 2022/0175617 A1
(43) Pub. Date: Jun. 9, 2022

(54) SYSTEM AND METHOD FOR APPLYING PATTERNS ON ARTICLES AND INSPECTION THEREOF

(71) Applicant: Tri-Star Technologies, Galveston, CA (US)

(72) Inventor: Igor Murokh, Santa Monica, CA (US)

(73) Assignee: Tri-Star Technologies, El Segundo, CA (US)

(21) Appl. No.: 17/437,392

(22) PCT Filed: Mar. 8, 2020
(86) PCT No.: PCT/US2020/021613

§ 371 Date: Sep. 8, 2021

Related U.S. Application Data
(60) Provisional application No. 62/816,055, filed on Mar. 8, 2019.

(51) Int. Cl. A61J 3/00; A23G 3/50; B23K 26/362; B23K 26/03

(52) U.S. Cl. CPC A61J 3/007; B23K 26/032; B23K 26/362; A23G 3/50

(57) ABSTRACT

Embodiments of a method and system for applying patterns on the surfaces of articles and inspecting the patterns are disclosed. A laser irradiation system has a laser transmission element, irradiation zone and irradiation inspection element. A set of articles is positioned within the irradiation zone and irradiated with laser energy from the transmission element during an irradiation period. The irradiation causes interactions between a beam and the article surfaces which transiently generate localized illuminations at the article surfaces during the interactions. The interactions also collectively form post-irradiation patterns in the article surfaces that persist after the interactions. An irradiation inspection image of the irradiation zone is captured during the irradiation period by the irradiation inspection element. The irradiation inspection image includes illumination patterns defined by the localized illuminations. If an illumination pattern fails to match the corresponding target pattern to which it is compared, the respective article is rejected.

### RELATED APPLICATIONS

This application claims the benefit of U.S. Provisional Application No. 62/816,055 filed Mar. 8, 2019, the contents which are incorporated by this reference in their entireties for all purposes as if fully set forth herein.

### TECHNICAL FIELD

The present disclosure relates to applying patterns to articles and inspecting the applied patterns for accuracy. More particularly, the present disclosure relates to a system and method for applying patterns, such as by laser irradiation, to discrete consumable or non-consumable articles and inspecting the presence and correctness of the applied patterns.

### BACKGROUND

The reaction of a solid surface to laser irradiation depends on many factors, including laser wavelength and power, exposure time, and optical properties. In many cases, the marking resulting from these interactions has a relatively low (50% or less) contrast. That makes it hard to use a regular inspection camera and software algorithms for quality control. In addition to high-resolution cameras, it typically requires special instruments to provide a uniform illumination of the markings under consideration (e.g. diffuse dome lights, optical filters and diffusers, etc.). The equipment is bulky and hard to install on a real marking system due to space constraints.

Conventional laser-marked soft gelatin capsules illustrate the difficulties. By way of example, the curved surface of the capsules focuses the light and creates bright spots (see, for example, reflections 140 in FIG. 7 caused by, for example, an ambient lighting 142 or an auxiliary lighting element 148 in FIG. 1) masking a part of the message and making it difficult or impossible to analyze. In addition, the illumination of relatively large area (such as an area with an array of six capsules at a time) is typically uneven and may cause optical character recognition (OCR) to reject some capsules that actually have perfect markings. Every rejection slows the production down and increases the cost of marking large volumes of pharmaceutical capsules, as normally rejected pharmaceutical capsules cannot be used without additional qualification efforts. Moreover, low contrast marking causes other erroneous rejects by conventional vision systems. For example, a normal capsule seam may be misinterpreted by a conventional inspection system as a stray or improper marking.

### SUMMARY

Certain deficiencies of the prior art are overcome by the provision of systems and methods for applying patterns on consumable or non-consumable articles and inspection thereof as disclosed herein.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic view of one non-limiting example system for applying patterns on the surfaces of articles and inspecting said patterns in accordance with the present disclosure;

FIG. 2 is a diagrammatic plan view plan view taken along direction 2-2 in FIG. 1 illustrating an example auxiliary inspection image captured before the irradiation period, and which may be analyzed to identify any article retention pockets within the irradiation zone which are not in possession of a respective article or any articles within the irradiation zone that may be damaged (e.g., misshapen);

FIG. 3 is a diagrammatic plan view taken along direction 2-2 in FIG. 1 illustrating an irradiation zone during an irradiation period, wherein articles are shown being irradiated with laser energy by way of a laser transmission element;

FIG. 4 is a diagrammatic magnified view of details 4 in FIG. 3, showing an article being irradiated with laser energy to cause an interaction between the laser beam and the article surface, wherein the interaction is shown transiently generating a localized illumination at the article surface, and part of a post-irradiation pattern is shown persisting in the article surface as a result of preceding interactions with the laser beam;

FIG. 5 is a diagrammatic plan view taken along direction 2-2 in FIG. 1 illustrating a captured irradiation inspection image including illumination patterns defined by the localized illuminations generated during the irradiation period;

FIG. 6 is a diagrammatic plan view taken along direction 2-2 in FIG. 1 illustrating an auxiliary inspection image of an irradiation zone captured after an irradiation period, and which may be analyzed to identify any articles within the irradiation zone that are damaged or lack a post-irradiation pattern;

FIG. 7 is a diagrammatic magnified view of an example article with a post-irradiation pattern thereon, and wherein reflections from ambient lighting are shown obscuring the contrast between the post-irradiation pattern and the background color of the article; and

FIG. 8 is a diagrammatic flow chart illustrating a non-limiting example method of applying patterns on the surfaces of articles and inspecting said patterns in accordance with the present disclosure, wherein the dashed lines denote steps which, individually or in some combination, may optionally be included in certain implementations of the method.

### DETAILED DESCRIPTION OF THE PREFERRED EMBODIMENTS

The present disclosure describes, in part, new systems and methods for creating a high contrast image that can be used for pattern analysis (e.g. OCR, quality control, etc.) of low contrast laser marking, micromachining and the like.

Referring now to the drawings, like reference numerals designate identical or corresponding features throughout the several views.

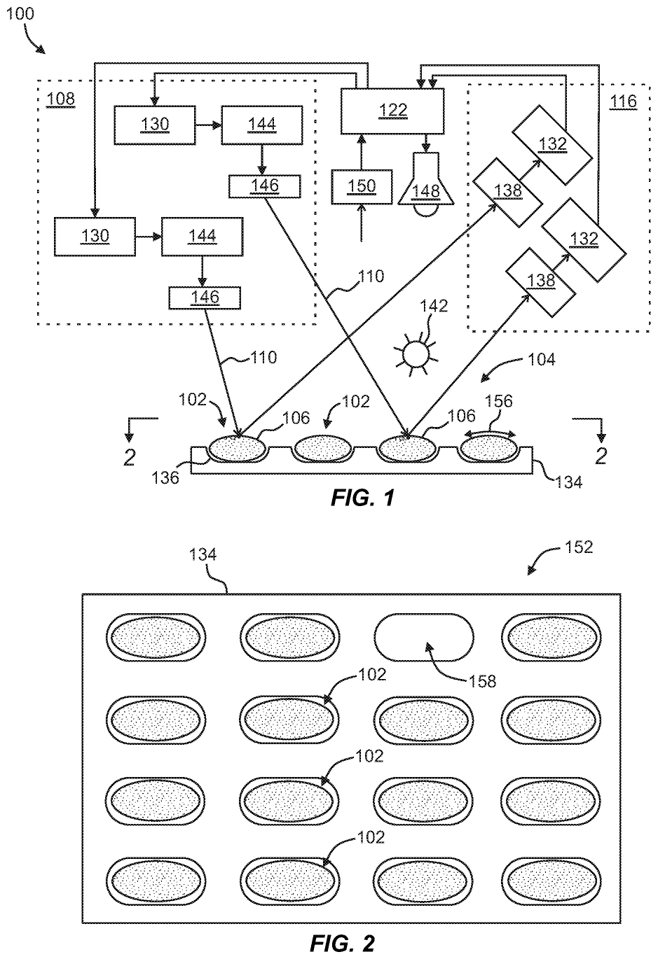

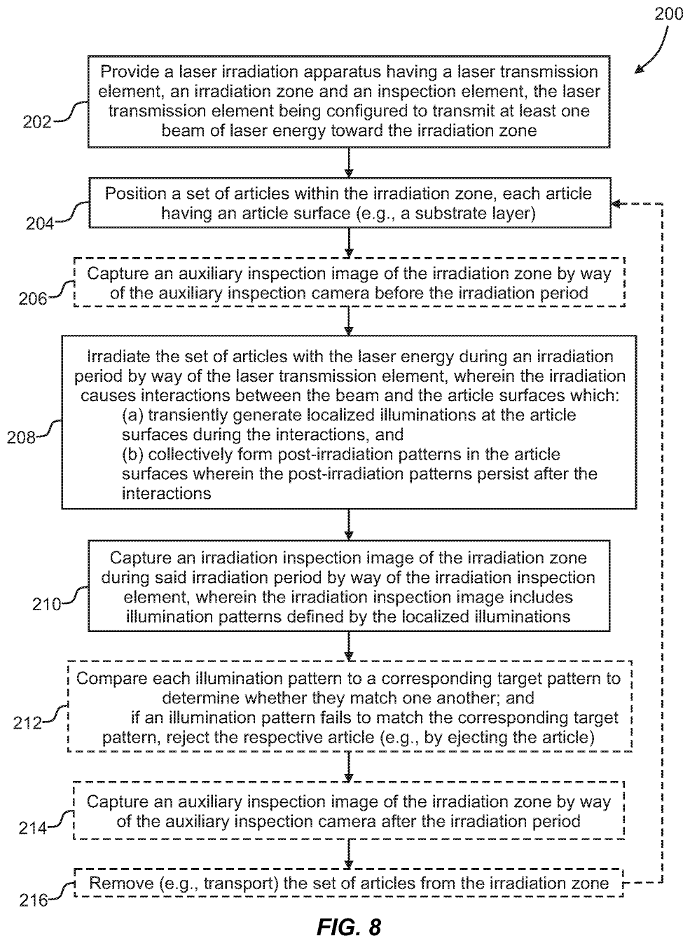

With reference to FIG. 1, one or more preferred embodiments of a system for applying patterns on the surfaces of articles and inspecting said patterns in accordance with the present disclosure are represented generally at 100. The system 100 may comprise an irradiation zone 104, a laser transmission element 108 and an irradiation inspection element 116. One or more associated methods involving a system 100 are represented in FIG. 8 at 200.

The irradiation zone 104 may be configured to receive a set 126 of articles 102 therein, wherein each article has an article surface 106. To facilitate this receipt, a transport element 134 with an array of article retention pockets 136 may be provided. The transport element 134 may be part of a conveyor subsystem such as a conveyer belt or transport wheel, or may be a tray that is manually (e.g. by hand) removable from and insertable into the irradiation zone.

The laser transmission element 108 may be configured to transmit at least one beam 110 of laser energy toward the irradiation zone 104 to irradiate the set of articles with the laser energy during an irradiation period. Referring to FIGS. 1, 3 and 4, the irradiation may be configured to cause interactions between the beam 110 and the article surfaces 106 which (a) transiently generate localized illuminations 112 at the article surfaces 106 during the interactions, and (b) collectively form post-irradiation patterns 114 in the article surfaces 106. The post-irradiation patterns 114 typically persist after the interactions. Each laser transmission element 108 may have an associated scanner 144 and lens 146.

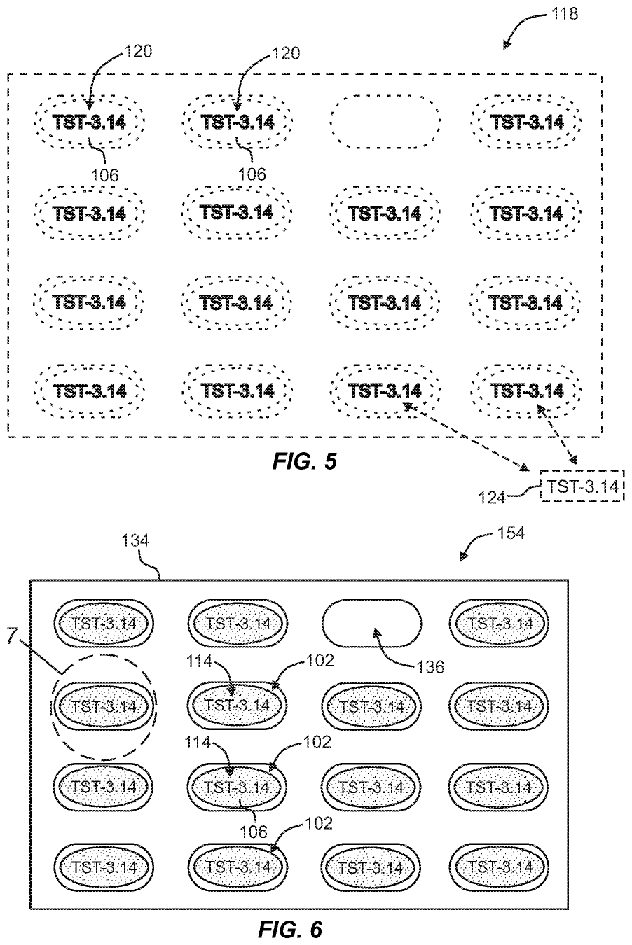

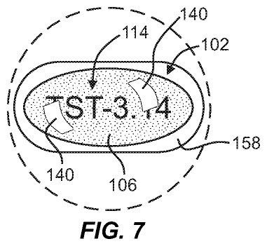

Referring to FIGS. 1 and 5, the irradiation inspection element 116 may be configured to capture an irradiation inspection image 118 of the irradiation zone 104 during a respective irradiation period. The irradiation inspection image 118 may include illumination patterns 120 defined by the aforementioned localized illuminations.

Referring to FIGS. 1 and 5, preferred embodiments of a system 100 may include a processor element 122 configured to compare the illumination patterns 120 to corresponding target patterns 124. Such a system 100 may be configured such that if an illumination pattern 120 fails to match the respective target pattern, the respective article 102 is rejected (for example, ejected from the system 100).

In particular embodiments of the system 100, the post-irradiation patterns 114 may be a respective marking. A marking may comprise, for example, one or more human or machine-readable alpha-numeric characters, or a 2-dimensional QR or bar code. In such embodiments, during the irradiation period the article surfaces 106 may have a first background luminance and the localized illuminations 112 may have an illumination luminance. After the irradiation period, the article surfaces 106 may have a second background luminance and the markings 114 may have a marking luminance which is different from the second background luminance. An illumination contrast may be defined by a relative difference between the first background luminance and the illumination luminance, and a marking contrast may be defined by a relative difference between the second background luminance and the marking luminance. The illumination contrast may preferably be at least four times greater in magnitude than the marking contrast. In some embodiments of the system 100, the illumination contrast may be 450%, 500%, 550% or even 600% greater than the marking contrast.

The illumination contrast and the marking contrast may preferably be defined, for example, as a relative difference between background (Lb) and marking luminance (Lm) calculated as (Lb-Lm)/Lb for the darker marking on a light background and (Lm-Lb)/Lm for the brighter marking on the darker background. That is the same as (L max−L min)/L max, where L min and L max is minimum and maximum luminance within the marking and its vicinity.

Since the illumination contrast is substantially greater than the marking contrast, optical character recognition (OCR) performed on the illumination patterns can have more tightly defined pass-fail parameters. This, in turn, ensures fewer acceptances of incorrectly marked articles without increasing the rejections of correctly marked ones. OCR error occurs when an incorrect marking is not identified and is therefore accepted as good, or a correct marking is not recognized and is therefore rejected as bad. OCR accuracy then may be defined herein as (N-Ne)/N, where N is the total number of markings evaluated in the OCR process and Ne is the total number of OCR errors. For practical purposes OCR accuracy calculation should preferably involve evaluation of at least 100 or at least 1000 articles.

In particular preferred embodiments of a system 100, each illumination pattern 120 may comprise at least one character, and the comparison may be configured to be performed by way of an OCR process having an OCR accuracy of at least 99%. This OCR accuracy may be based on at least 1000 said articles 102 consecutively subjected to the irradiation. Moreover, in particular preferred embodiments of a system 100, each illumination pattern 120 may comprise at least two characters, and the comparison may be configured to be performed by way of an OCR process having an OCR accuracy of at least 99.9% for at least 1000 said articles 102 consecutively subjected to said irradiating.

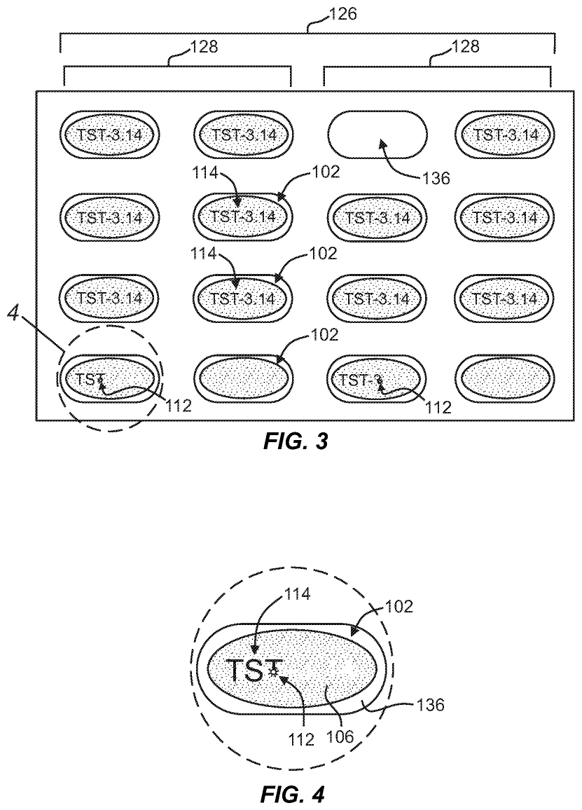

Referring to FIGS. 1 and 3, in particular embodiments of a system 100, the laser transmission element 108 may comprise multiple lasers 130. In such embodiments, each laser 130 may be configured to irradiate a respective subset 128 of the respective articles 102. Moreover, in such embodiments of a system 100, the irradiation inspection element 116 may comprise multiple irradiation cameras 132. Each of the irradiation cameras 132 may be configured to capture a portion of the irradiation inspection image corresponding to the irradiation by a respective said laser 130.

Referring to FIGS. 1 and 2, certain preferred embodiments of a system 100 may further comprise an auxiliary inspection camera 150. The auxiliary inspection camera may be configured for capturing an auxiliary inspection image 152 of the irradiation zone 104 before the irradiation period. In such case, the processor element 122 may be configured to analyze the auxiliary inspection image 152 to identify, for example, any article retention pockets 158 within the irradiation zone which are not in possession of a respective article 102, or any articles 102 within the irradiation zone 104 that are damaged (e.g., have an irregular shape inconsistent with a pre-programmed target shape).

Referring to FIGS. 1 and 6, particular preferred embodiments of a system 100 may further comprise an auxiliary inspection camera 150 for capturing an auxiliary inspection image 154 of the irradiation zone after the irradiation period. In such case, the processor element 122 may be configured to analyze the auxiliary inspection image 154 to identify any articles 102 within the irradiation zone 104 that are damaged or lack a post-irradiation pattern 114.

Depending upon the particular embodiment of the system 100, the post-irradiation pattern 114 may be a material void (for example, an etching into the article surface).

Depending upon the particular implementation of the system 100, the articles 102 may be consumable articles. The consumable articles may comprise pharmaceutical substances, for example, where the article 102 is a medicinal tablet, capsule or the like. In the alternative, the consumable articles 102 may be candies. It is also contemplated that, in particular implementations of a system 100, the articles 102 may be non-consumable articles such as those found in the medical device, electronics, aerospace or other industries.

Referring to FIG. 8, one or more preferred implementations of a method for applying patterns on the surfaces of articles and inspecting said patterns are represented generally at 200. A method 200 may comprise various combination of one or more steps. For example, at block 202 and with reference to FIG. 1, a laser irradiation system (such as the system shown at 100 in FIG. 1) may be provided which has a laser transmission element 108, an irradiation zone 104 and an irradiation inspection element 116. The laser transmission element 108 may be configured to transmit at least one beam 110 of laser energy toward the irradiation zone 104.

Referring to FIGS. 1, 3 and 8, at block 204, a set 126 of articles 102 may be position within the irradiation zone 104, each article 102 having an article surface 106. At block 208, the set of articles 102 may be irradiated with the laser energy during an irradiation period by way of the laser transmission element 108, wherein the irradiation causes interactions between the beam 110 and the article surfaces 106. Referring to FIGS. 3 and 4, these interactions may (a) transiently generate localized illuminations 112 at the article surfaces 106 during the interactions, and (b) collectively form post-irradiation patterns 114 in the article surfaces 106. The post-irradiation patterns 114 may be configured to persist after the interactions (for example, like markings or etchings which may indelible).

Referring to FIGS. 1 and 5, at block 210, an irradiation inspection image 118 of the irradiation zone 104 is captured during the irradiation period by way of the irradiation inspection element 116. The irradiation inspection image 118 includes illumination patterns 120 defined (e.g., collectively) by the localized illuminations 112.

Referring to FIGS. 1 and 5, at block 212, each illumination pattern 120 may be comparing to a corresponding target pattern 124 to determine whether they match one another. If an illumination pattern 120 fails to match the corresponding target pattern, the respective article may be rejected (for example, by way of ejection from the system 100).

In particular preferred implementations of the method 200, each illumination pattern 120 may comprise at least one character (for example, an alpha-numeric character in one or more languages, or a non-alphanumeric symbol, code or graphical design), and the step of comparing 212 may be performed by way of optical character recognition having an OCR accuracy of at least 99%. In such implementations, the optical character recognition may have an OCR accuracy of at least 99% for at least 1000 articles 102 consecutively subjected to the step of irradiating 208.

In certain preferred implementations of the method 200, each illumination pattern 120 may comprise at least two characters, and the step of comparing 212 may be performed by way of optical character recognition having an OCR accuracy of at least 99.9%. In such implementations, the optical character recognition may have an OCR accuracy of at least 99.9% for at least 1000 articles 102 consecutively subjected to the step of irradiating 208.

Referring it to FIGS. 1, 3 and 8, in certain preferred implementations of the method 200, the laser transmission element 108 may comprise multiple lasers 130, and in the irradiating step 208, each laser 130 may irradiate a respective subset 128 of the articles 102. Moreover, the irradiation inspection element 116 may comprise multiple irradiation cameras 132, and in the step of capturing 210, each of the irradiation cameras 132 may capture a portion of the irradiation inspection image 118 corresponding to the irradiation by a respective said laser 130.

In particular implementations of the method 200, the post-irradiation patterns 120 may be markings. In such implementations, during the irradiation period the article surfaces 106 may have a first background luminance the localized illuminations 112 may have an illumination luminance. After the irradiation period, the article surfaces 106 may have a second background luminance and the markings 114 may have a marking luminance which is different from the second background luminance. An illumination contrast may be defined by a relative difference between the first background luminance and the illumination luminance, and a marking contrast may be defined by a relative difference between the second background luminance and the marking luminance. The illumination contrast may preferably be at least four times greater in magnitude than the marking contrast. In some implementations of the method 200, the illumination contrast may be 450%, 500%, 550% or even 600% the marking contrast.

With regard to the method 200, the illumination contrast and the marking contrast may preferably be defined, for example, as a relative difference between background (Lb) and marking luminance (Lm) calculated as (Lb-Lm)/Lb for the darker marking on a light background and (Lm-Lb)/Lm for the brighter marking on the darker background. That is the same as (L max−L min)/L max, where L min and L max is minimum and maximum luminance within the marking and its vicinity.

Referring to FIGS. 1, 2 and 8, particular implementations of the method 200 may further comprise capturing 206 an auxiliary inspection image 152 of the irradiation zone 104 by way of an auxiliary inspection camera 150 before the irradiation period. Then, the auxiliary inspection image 152 may be analyzed to identify any article retention pockets 136 within the irradiation zone 104 which are not in possession of a respective article 102, or any articles 102 within the irradiation zone 104 that are damaged (e.g., have an irregular shape inconsistent with a pre-programmed target shape).

Referring to FIGS. 1, 6 and 8, certain implementations of the method 200 may further comprise capturing 214 an auxiliary inspection image 154 of the irradiation zone 104 by way of an auxiliary inspection camera 150 after the irradiation period. In such implementations, the auxiliary inspection image 154 may be analyzed to identify any articles 102 within the irradiation zone 104 that are damaged or lack a post-irradiation pattern 114.

Depending upon the particular implementation of the method 200, the post-irradiation pattern 114 may be a material void (for example, an etching into the article surface).

Depending upon the particular implementation of the method 200, the articles 102 may be consumable articles. The consumable articles 102 may comprise pharmaceutical substances, for example, where the article 102 is a medicinal tablet, capsule or the like. In the alternative, the consumable articles 102 may be candies. It is also contemplated that, in particular implementations of a method 100, the articles 102 may be non-consumable articles such as those found in the medical device, electronics, aerospace or other industries.

In particular implementations of a system 100 or method 200, the interactions generate plasma, and that plasma generates the localized illuminations 112. Also, referring to FIG. 1, in certain implementations of a system 100 or method 200, the post-irradiation patterns 114 may each extend across curved portions 156 of respective article surfaces 106.

Referring to FIG. 1, in certain preferred embodiments of a system 100 or method 200, the irradiation inspection element 116 may comprise at least one irradiation camera 132 and at least one light attenuator 138 optically disposed between the irradiation zone 104 and the at least one irradiation camera 132. The at least one light attenuator 138 may be, for example, a polarizer, a diffuser, a combination thereof or the like.

In particular implementations of a method 200, the irradiation inspection image 118 may be used to analyze the articles 102 for surface defects or material impurities. In particular implementations of the system 100 or method 200, the processor element 122 may be configured to use the irradiation inspection image 118 to analyze the articles 102 for surface defects or material impurities.

In certain preferred implementations of a system 100 or method 200, no dichroic mirrors are included within the irradiation inspection element 116 or optically disposed between the irradiation zone 104 and any portion of the irradiation inspection element 116. Alternatively, or in addition, in particular preferred implementations of a system 100 or method 200, no scanners are included within the irradiation inspection element 116 or optically disposed between the irradiation zone 104 and any portion of the irradiation inspection element 116.

In particular preferred implementations of a system 100 or method 200, the beam 110 of laser energy may be in the Ultraviolet (UV) spectrum, and the article surface 106 may be a substrate layer containing titanium dioxide in sufficient quantity or density to cause a visible marking 114 to persist in the article surface 106 after the laser beam 110 interacts with the surface 106.

Advantageously, by capturing an inspection image during the actual laser marking, many of the deficiencies of the prior art are overcome, as intense light is emitted from the nearest vicinity of the laser-surface-contact points. In many embodiments of the system 100 and method 200, this light (e.g., from plasma) is so bright that it must be attenuated by, for example polarization filters. The higher-contrast image may be much more easily analyzed with any pattern recognition software.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of applying patterns on the surfaces of articles and inspecting said patterns, the method comprising:
providing a laser irradiation system having a laser transmission element, an irradiation zone and an irradiation inspection element, the laser transmission element being configured to transmit at least one beam of laser energy toward the irradiation zone;
positioning a set of articles within the irradiation zone, each article having an article surface;
irradiating the set of articles with the laser energy during an irradiation period by way of the laser transmission element, wherein the irradiation causes interactions between the beam and the article surfaces which
(a) transiently generate localized illuminations at the article surfaces during the interactions, and
(b) collectively form post-irradiation patterns in the article surfaces wherein the post-irradiation patterns persist after the interactions; and
capturing an irradiation inspection image of the irradiation zone during said irradiation period by way of the irradiation inspection element, wherein the irradiation inspection image includes illumination patterns defined by the localized illuminations.

2. A method as defined in claim 1, further comprising, after the step of capturing:
comparing each illumination pattern to a corresponding target pattern to determine whether they match one another; and
if an illumination pattern fails to match the corresponding target pattern, rejecting the respective article.

3. A method as defined in claim 2, wherein
(a) each illumination pattern comprises at least one character; and
(b) the step of comparing is performed by way of optical character recognition having an OCR accuracy of at least 99%.

4. A method as defined in claim 3 wherein, for at least 1000 said articles consecutively subjected to said irradiating, the optical character recognition has an OCR accuracy of at least 99%.

5. A method as defined in claim 2, wherein
(a) each illumination pattern comprises at least two characters; and
(b) the step of comparing is performed by way of optical character recognition having an OCR accuracy of at least 99.9%.

6. A method as defined in claim 5 wherein, for at least 1000 said articles consecutively subjected to said irradiating, the optical character recognition has an OCR accuracy of at least 99.9%.

7. A method as defined in claim 1, wherein
(a) the laser transmission element comprises multiple lasers; and
(b) in the irradiating step, each laser irradiates a respective subset of said articles.

8. A method as defined in claim 7, wherein
(a) the irradiation inspection element comprises multiple irradiation cameras; and
(b) in the step of capturing, each of the irradiation cameras captures a portion of the irradiation inspection image corresponding to the irradiation by a respective said laser.

9. A method as defined in claim 1, wherein the post-irradiation patterns are markings.

10. A method as defined in claim 9, wherein
(a) during the irradiation period
(i) the article surfaces have a first background luminance; and
(ii) the localized illuminations have an illumination luminance;
(b) after the irradiation period
(i) the article surfaces have a second background luminance; and
(ii) the markings have a marking luminance which is different from the second background luminance;
(c) an illumination contrast is defined by a relative difference between the first background luminance and the illumination luminance;
(d) a marking contrast is defined by a relative difference between the second background luminance and the marking luminance; and
(e) the illumination contrast is greater in magnitude than the marking contrast.

11. A method as defined in claim 10, wherein the illumination contrast is at least four times greater in magnitude than the marking contrast.

12. A method as defined in claim 1, further comprising
capturing an auxiliary inspection image of the irradiation zone by way of the auxiliary inspection camera before the irradiation period;
analyzing the auxiliary inspection image to identify
(a) any article retention pockets within the irradiation zone which are not in possession of a respective said article; or
(b) any articles within the irradiation zone that are damaged.

13. A method as defined in claim 1, further comprising
capturing an auxiliary inspection image of the irradiation zone by way of the auxiliary inspection camera after the irradiation period; and
analyzing the auxiliary inspection image to identify any articles within the irradiation zone that are damaged or lack a post-irradiation pattern.

14. A method as defined in claim 1, wherein the post-irradiation pattern is a material void.

15. A method as defined claim 1, wherein the articles are consumable articles.

16. A method as defined in claim 15, wherein the consumable articles comprise pharmaceutical substances.

17. A method as defined in claim 15, wherein the consumable articles are candies.

18. A method as defined in claim 1, wherein the post-irradiation patterns each extend across curved portions of respective said article surfaces.

19. A method as defined in claim 1, wherein the irradiation inspection element comprises
(a) at least one irradiation camera; and
(b) at least one light attenuator optically disposed between the irradiation zone and the at least one irradiation camera.

20. A method as defined in claim 19, wherein the at least one light attenuator is selected from the group consisting of polarizers and diffusers.

21. A method as defined in claim 1, further comprising
using the irradiation inspection image to analyze the articles for surface defects or material impurities.

22. A method as defined in claim 1, wherein
(a) the interaction generates plasma; and
(b) the plasma generates the localized illuminations.

23. A method as defined in claim 1, wherein no dichroic mirrors are
(a) included within the irradiation inspection element; or
(b) optically disposed between the irradiation zone and any portion of the irradiation inspection element.

24. A method as defined in claim 1, wherein no scanners are
(a) included within the irradiation inspection element; or
(b) optically disposed between the irradiation zone and any portion of the irradiation inspection element.

25. A system for applying patterns on the surfaces of articles and inspecting said patterns, the system comprising:
an irradiation zone configured to receive a set of articles therein, wherein each article has an article surface;
a laser transmission element configured to transmit at least one beam of laser energy toward the irradiation zone to irradiate the set of articles with the laser energy during an irradiation period, wherein the irradiation is configured to cause interactions between the beam and the article surfaces which
(a) transiently generate localized illuminations at the article surfaces during the interactions, and
(b) collectively form post-irradiation patterns in the article surfaces wherein the post-irradiation patterns persist after the interactions; and
an irradiation inspection element configured to capture an irradiation inspection image of the irradiation zone during said irradiation period, wherein the irradiation inspection image includes illumination patterns defined by the localized illuminations; and
a processor element configured to compare the illumination patterns to corresponding target patterns, wherein if an illumination pattern fails to match the respective target pattern, the respective article is rejected.

26. A system as defined in claim 25, wherein
(a) each illumination pattern comprises at least one character; and
(b) the comparison is configured to be performed by way of optical character recognition having an OCR accuracy of at least 99% for at least 1000 said articles consecutively subjected to said irradiating.

27. A system as defined in claim 25, wherein
(a) each illumination pattern comprises at least two characters; and
(b) the comparison is configured to be performed by way of optical character recognition having an OCR accuracy of at least 99.9% for at least 1000 said articles consecutively subjected to said irradiating.

28. A system as defined in claim 25, wherein
(a) the laser transmission element comprises multiple lasers; and
(b) each laser is configured to irradiate a respective subset of said articles.

29. A system as defined in claim 28, wherein
(a) the irradiation inspection element comprises multiple irradiation cameras; and
(b) each of the irradiation cameras is configured to capture a portion of the irradiation inspection image corresponding to the irradiation by a respective said laser.

30. A system as defined in claim 25, wherein the post-irradiation pattern is a marking.

31. A system as defined in claim 30 wherein
(a) during the irradiation period
(i) the article surfaces have a first background luminance; and
(ii) the localized illuminations have an illumination luminance;
(b) after the irradiation period
(i) the article surfaces have a second background luminance; and
(ii) the markings have a marking luminance which is different from the second background luminance;
(c) an illumination contrast is defined by a relative difference between the first background luminance and the illumination luminance;
(d) a marking contrast is defined by a relative difference between the second background luminance and the marking luminance; and
(e) the illumination contrast is greater in magnitude than the marking contrast.

32. A system as defined in claim 31 wherein the illumination contrast is at least four times greater in magnitude than the marking contrast.

33. A system as defined in claim 25, further comprising
an auxiliary inspection camera for capturing an auxiliary inspection image of the irradiation zone before the irradiation period;
wherein the processor element is configured to analyze the auxiliary inspection image to identify
(a) any article retention pockets within the irradiation zone which are not in possession of a respective said article; or
(b) any articles within the irradiation zone that are damaged.

34. A system as defined in claim 25, further comprising
an auxiliary inspection camera for capturing an auxiliary inspection image of the irradiation zone after the irradiation period;
wherein the processor element is configured to analyze the auxiliary inspection image to identify any articles within the irradiation zone that are damaged or lack a post-irradiation pattern.

35. A system as defined in claim 25 wherein the post-irradiation pattern is a material void.

36. A system as defined in claim 25, wherein the articles are consumable articles.

37. A system as defined in claim 36 wherein the consumable articles comprise pharmaceutical substances.

38. A system as defined in claim 36 wherein the consumable articles are candies.

39. A system as defined in claim 25, wherein the post-irradiation patterns each extend across curved portions of respective said article surfaces.

40. A system as defined in claim 25, wherein the irradiation inspection element comprises
(a) at least one irradiation camera; and
(b) at least one light attenuator optically disposed between the irradiation zone and the at least one irradiation camera.

41. A system as defined in claim 40 wherein the at least one light attenuator is selected from the group consisting of polarizers and diffusers.

42. A system as defined in claim 25, wherein the processor element is configured to use the irradiation inspection image to analyze the articles for surface defects or material impurities.

43. A system as defined in claim 25, wherein
(a) the interaction generates plasma; and
(b) the plasma generates the localized illuminations.

44. A system as defined in claim 25, wherein no dichroic mirrors are
(a) included within the irradiation inspection element; or
(b) optically disposed between the irradiation zone and any portion of the irradiation inspection element.

45. A system as defined in claim 25, wherein no scanners are
(a) included within the irradiation inspection element; or
(b) optically disposed between the irradiation zone and any portion of the irradiation inspection element.
